(19) United States
(12) Patent Application Publication
(10) Pub. No.: US 2010/0250726 A1
(43) Pub. Date: Sep. 30, 2010

(54) APPARATUS AND METHOD FOR ANALYZING TEXT IN A LARGE-SCALED FILE

(75) Inventors: Moshe Moses, Kfar Saba (IL); Arik Kfir, Givatayem (IL); Yariv Davidovich, Tel Aviv (IL)

Correspondence Address: SOROKER-AGMON ADVOCATE AND PATENT ATTORNEYS, NOLTON HOUSE, 14 SHENKAR STREET, HERZELIYA PITUACH, 46725, IL

(73) Assignee: INFOLINKS INC., Palo Alto, CA (US)

(21) Appl. No.: 12/409,539

(22) Filed: Mar. 24, 2009

(51) Int. Cl. G06F 15/173

(52) U.S. Cl. 709/224

(57) ABSTRACT

The subject matter discloses a system for analyzing a large-scaled file downloaded to a user's computerized device in segments that comprises a detection module for reviewing at least a portion of the large-scaled file and detects new segments added to the large-scaled file since a previous review of the large-scaled file. The system also comprises a triggering module for triggering the detection module and an analyzing module for analyzing at least the text of the at least one new segment detected by the detection module.

### BACKGROUND OF THE INVENTION

1. Field of the Invention

The present invention relates to text analysis in general, and to analyzing text in large-scaled files in particular.

2. Discussion of the Related Art

The internet has evolved as an arena for commercial activity, including e-commerce and advertisements presented, for example, in banners, media files within hypertext markup language (HTML) files downloaded to the users' devices, and the like. Such methods of advertising may seem intrusive to users and website owners since they involve interrupting content and data displayed to the users and draw their attention. One common solution for less-intrusive online advertisement uses text content from a web page displayed to a user as hyperlinks to commercial content, also known as in-text advertisement. In many cases, the text is identified by a double underline to differentiate it from regular hyperlinks. The text to be marked up is selected by a computerized application according to predefined parameters and ad campaigns stored in a server.

Some HTML files also called web pages contain a larger volume of content, for example text that requires longer periods of time to download from the web server that stores the content, depending on the user's connection speed. For example, download of a rich web page may take several seconds up to a few minutes, which is considered relatively poor performance in the user experience perspective. Such web pages may contain thousands of words and graphic elements, and require large memory space. For example, some online articles contain over 2,000 words, or about 2 Megabytes. Some technologies, such as asynchronous JavaScript and XML (AJAX), address large-scaled web pages or other online files by enabling retrieval of data from a web server asynchronously in the background without interfering with the display and behavior of the existing page. Hence, some of the content is downloaded and displayed when the web page is first opened by the user, while other portions of the content can be downloaded from the web server without requiring reloading of the entire web page or refreshing it.

When analyzing the text in a web page, the application detects the content after it is downloaded from the web server to the user's device, such that the content is displayed at the user's device along with the hyperlinks or other markup technology. When analyzing large scaled content displayed to the user using AJAX only as the first segment of content is received at the user's device, most of the content is not analyzed and as a result, most of the content used for advertisement purposes. Further, no current solution provides for just in time analysis (JIT) to analyze the content only on demand.

There is therefore a need for a system and method for analyzing text in large scaled document without reducing the performance provided to the user by analyzing only a specific segment at a time. In some cases, analyzing the entire large-scaled content at the same time without using AJAX can consume large portion of the user's device resources.

### SUMMARY OF THE PRESENT INVENTION

It is an object of the subject matter to disclose a method of analyzing a large-scaled file downloaded to a user's computerized device in segments, comprises determining to detect changes in the large-scaled file, activating a computerized module to review the large-scaled file and reviewing at least a portion of the large-scaled file to determine whether an at least one new segment has been added to the large-scaled file since a previous review of the large-scaled file.

In some embodiments, the method further comprises a step of collecting the text from the at least one new segment. In some embodiments, the method further comprises a step of determining the start point for reviewing the at least a portion of the large-scaled file.

In some embodiments, the method further comprises a step of sending the text from the at least one new segment to an analyzing module, to be associated with commercial content.

In some embodiments, the method further comprises a step of determining at least one word from the large-scaled file to be associated with commercial content. In some embodiments, the method further comprises a step of associating commercial content to at least one word from the at least one new segment.

In some embodiments, the method further comprises a step of assigning a value or flag to previously reviewed segments of the large-scaled file. In some embodiments, reviewing the at least a portion of the large-scaled document begins at a pointer assigned at a previous review of the large-scaled file. In some embodiments, the large-scaled file is downloaded using an asynchronous technology. In some embodiments, the asynchronous technology is AJAX.

It is another object of the subject matter to disclose a computer program product, comprising a computer usable medium having a computer readable program code embodied therein, said computer readable program code adapted to be executed to implement a method of analyzing a large-scaled file downloaded to a user's computerized device in segments, comprises determining to detect changes in the large-scaled file, activating a computerized module to review the large-scaled file and reviewing at least a portion of the large-scaled file to determine whether an at least one new segment has been added to the large-scaled file since a previous review of the large-scaled file

It is another object of the subject matter to disclose a system for analyzing a large-scaled file downloaded to a user's device in segments, comprising a detection module for reviewing at least a portion of the large-scaled file and detect an at least one new segment added to the large-scaled file since a previous review of the large-scaled file, a triggering module for triggering the detection module and an analyzing module for analyzing at least the text of the at least one new segment detected by the detection module.

In some embodiments, the trigger is provided in a periodic manner. In some embodiments, the system further comprises a collection module for collecting the text from the at least one new segment and send the text to the analyzing module. In some embodiments, the triggering module is a timer indicating the time elapsed since a previous review of the at least a portion of the large-scaled document.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are designated by the same numerals or letters.

FIG. 1 shows a computerized environment for handling large-scaled file, according to some exemplary embodiments of the subject matter;

FIG. 2 shows a large-scaled file downloaded to a user's device, in accordance with some exemplary embodiments of the subject matter;

FIG. 3 shows a computerized module for handling a large-scaled file downloaded to a user's device, in accordance with some exemplary embodiments of the subject matter;

FIG. 4 shows a data structure of a large-scaled file detected by the computerized module, in accordance with some exemplary embodiments of the subject matter; and,

FIG. 5 shows a flow in which a computerized entity handles a large-scaled file downloaded to a user's device, in accordance with some exemplary embodiments of the subject matter.

### DETAILED DESCRIPTION OF THE PREFERRED EMBODIMENT

One technical problem dealt in the disclosed subject matter is to enable separate analysis of different segments of a large-scaled document represented as a computerized file downloaded from a web site at a user's device. Another technical problem is to analyze content provided using asynchronous technology upon demand or command for a new segment to be downloaded to the user's computerized device According to the disclosed subject matter, a large-scaled document is a document or message downloaded from a web server, web application or a mail server in two or more segments. The subject matter relates to any file or document residing on a computerized device connected to a network from which the file or document can be downloaded or requested from another computerized device on the said network For example, a large-scaled document or file may be an article located on a communication server, a blog presenting several articles in one web page, web pages in forums or social networks, and the like.

One technical solution comprises a computerized module that detects whether a new segment of the large-scaled file has been downloaded or requested to be downloaded from the communication server in a discrete manner, for example once every predetermined period of time. One example of such period of time would be every one (1) second. The size of segments may vary according to the communication server, such as a web server, according to the header added to the file representing a segment, according to communication protocols, the user's device and the like. When a new segment is detected as recently downloaded, such segment is transmitted to an adaptive server and analyzed, in the adaptive in-text server that contains campaigns and keywords. Such in-text server is an adaptive server that contains commercial content, such as campaigns, a plurality of keywords and a set of rules. Other commercial content to be associated with words contained in the segment may be commercials, product ranks, categories, user's behavior when accessing specific commercials, geographic and language related data and the like. In some exemplary embodiments of the disclosed subject matter, the in-text server determines at least one word to be marked at the previously detected segments in the large-scaled file. Thus, the in-text server may review the downloaded segment solely, not the entire large-scaled file, which improves performance of the text analysis.

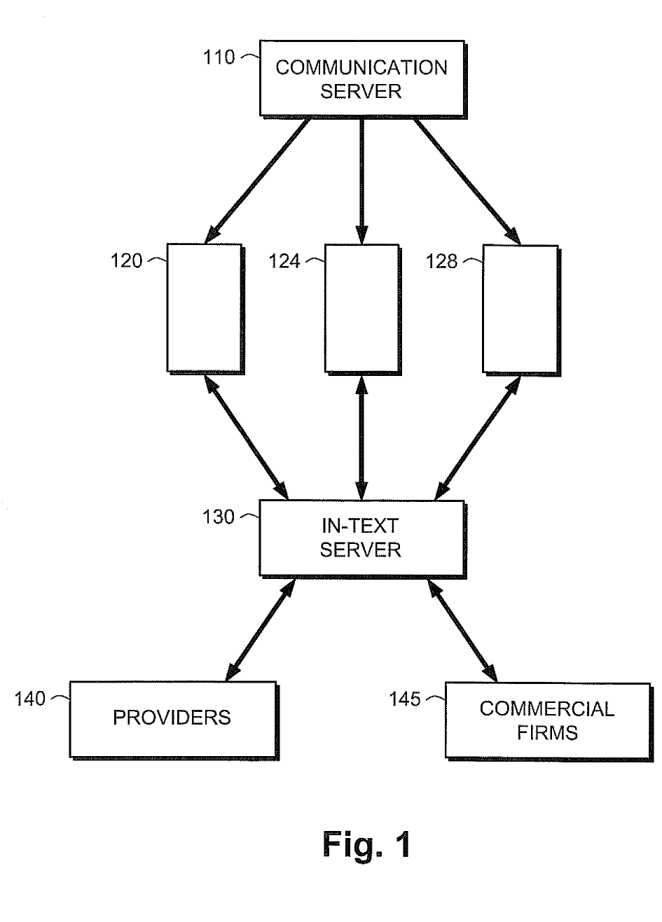

FIG. 1 shows a computerized environment for handling large-scaled documents, according to some exemplary embodiments of the subject matter. Computerized environment 100 comprises a plurality of users' computerized devices 120, 124, 128 that receive content from a communication server 110. In some cases, the communication server 110 is a web server and the content comprises web pages, more specifically web pages that contain large-scaled documents represented by files. In some other embodiments, the content is email messages, and the communication server 110 is an email server. In other embodiments, the communication server 110 is a server that handles instant messaging applications, such as ICQ, MSN messenger and the like. The users' computerized devices 120, 124, 128 may be a personal computer, a television having an input/output device such as a remote control or a keyboard. Other examples for user's computerized devices are wireless or mobile devices such as mobile phone, Personal Digital Assistance (PDA), and other mobile devices having a screen and an input device and are able to connect to a data network, and the like. An in-text server 130 is provided to associate words in the large-scaled document to commercial content, such as advertisements, hyperlinks to a web page or to a web application that contain commercial content. The in-text server 130 preferably contains data related to content providers, advertisements, ad campaigns, data related to consumers and the like. The in-text server 130 may also contain data related to billing options of the campaigns, such as bids, a set of rules used to select one or more words from the file representing the large-scaled document, and to select the advertisement, link or application to maximize the campaigns potential. In some embodiments of the disclosed subject matter, the in-text server 130 communicates with providers 140 or with commercial firms 145. Such providers 140 hold campaigns and data related to the campaigns. In many cases, the data related to campaigns comprises the subject of the campaign, price, and the message to be displayed the like. When content is sent from the user's computerized device 120, 124, 128 to the in-text server 130 for analysis, the in-text server determines words to be marked up according to offers from the s providers 140 or from the firms 145 themselves. Next, the words determined to be marked up are transmitted to the user's computerized device 120, 124, 128 for marking said words.

In some exemplary embodiments of the disclosed subject matter, the content requested by the users or the users' devices 120, 124, 128 from the communication server 110 is later received at the in-text server 130 that determines which words, group of words or another portion of the document is to be associated with the commercial content. In other exemplary embodiments of the disclosed subject matter, the content requested by the users or the users' computerized devices 120, 124, 128 from the communication server 110 is sent to the users computerized devices 120, 124, 128. In such case, a computerized application that resides within or communicates with the users' computerized devices 120, 124, and 128 may contain a computerized module to determine which words or another portion of the document is to be associated with the commercial content.

In some embodiments of the disclosed subject matter, the communication server 110 starts sending segments of the large-scaled file representing the document to the user's computerized devices 120, 124, 128 upon a user's request. Such a request can be made by a user entering a web page in a web browser type application, the web browser application, such as Internet explorer, Firefox and the like, issues a request to the communication server 110. The segments received at the user's computerized devices 120, 124, 128 are displayed using the said browser. In some exemplary embodiments of the disclosed subject matter, a computerized module 122 is sent to the user's computerized device 120 in addition to the content sent from the communication server 110 and handles the analysis of the large-scaled file sent from the communication server 110 to the user's computerized device 120. Such computerized module 122 may be an executable file, script, java script, hardware module or any other installable or downloadable computerized entity desired by a person skilled in the art. In some exemplary embodiments of the disclosed subject matter, the computerized module 122 is embedded within the browser, so it can detect the request to the communication server 110 in real time. The computerized module 122 may contain or be connected to an activation module (not shown), such as a timer connected to a processor, that activates the computerized module 122 every predefined period of time, for example 5 seconds. The computerized module 122 may function as a detector for detecting new segments and sending the newly downloaded segments to the in-text server 130 for analysis.

In-text server 130 preferably stores information that relates to determining one or more words to be marked up when displayed to the user. Such marked up text, after associated with commercial content, may be associated with a hyperlink or a bubble, such that when the user points, clicks or hovers on the word or group of words, a window or a bubble may be displayed to the user. When the computerized module 122 detects download of a new segment of the large-scaled document, a notification message is issued to the In-text server 130, or to another entity that analyzes the content of the large-scaled document. Such notification may contain at least a portion of the detected segment, metadata related to the large-scaled document or to a web page from which the large-scaled document was downloaded or another source of the large-scaled document, or predefined keywords. In some embodiments of the disclosed subject matter, the In-text server 130 determines which of the words or sentences of the segment are to be marked. The In-text server 130 may also determine other optional parameters, such as the visual aspect of marking up, the associated commercial content and the like, according to data residing in the In-text server 130 and a predefined set of rules.

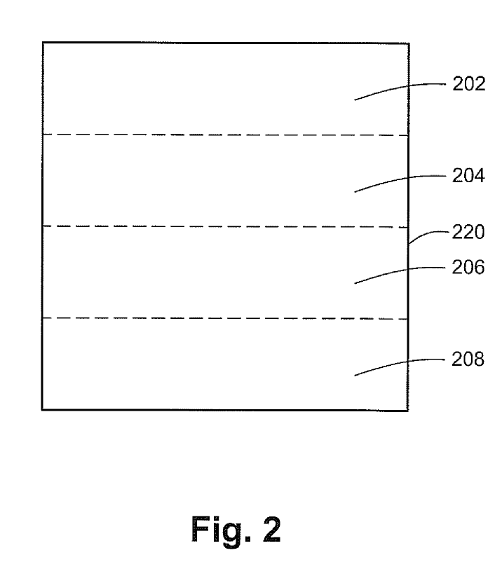

FIG. 2 shows a large-scaled document downloaded to a user's computerized device, in accordance with some exemplary embodiments of the subject matter. Large-scaled document 220 resides within a communication server (such as 110 of FIG. 1), and is requested by the user's computerized device 120. The download of the large-scaled document 220 is one time consuming element, in addition of analyzing and parsing the document The large-scaled document may be downloaded using asynchronous technology to the user's computerized device, or in its entirety. In the asynchronous case, large-scaled document 220 is segmented and downloaded in segments to the user's computerized device to improve performance of the user's computerized device (such as 120 of FIG. 1) and the look and feel of the web page for the user. When a first segment 202 is received at the user's computerized device 120, the web page that relates to the entire large-scaled document 220 is first displayed to the user, containing the first segment 202 only. The other segments may be downloaded and analyzed while only the first segment 202 is displayed to the user. Next, when other segments, such as 204, 206 and 208 are downloaded to the user's computerized device 120, the web page is not required to be refreshed, and the user can view the entire large-scaled document 220 representing the content of the web page downloaded in separate segments. In accordance with some exemplary embodiments of the disclosed subject matter, a computerized module (not shown) that resides within the user's computerized device 120 detects the next segment downloaded to the user's computerized device 120 after it is displayed by the browser. In other exemplary embodiments of the subject matter, the entire large-scaled document 220 is downloaded in one piece, not in several segments, but is analyzed and displayed in segments. In such embodiments, the computerized module (not shown) divides the large-scaled document 220 before analysis. The computerized module (not shown) sends a notification message to the in-text server (such as 130 of FIG. 1) after a new segment is detected, to determine the words to markup. Next, at least some of the words in the segment are marked when the detected segment of the large-scaled document 220 is displayed at the user's computerized device 120 containing the marked up words or sentences. Next, the computerized module (not shown) detects whether another segment of the large-scaled document 220 is to be analyzed.

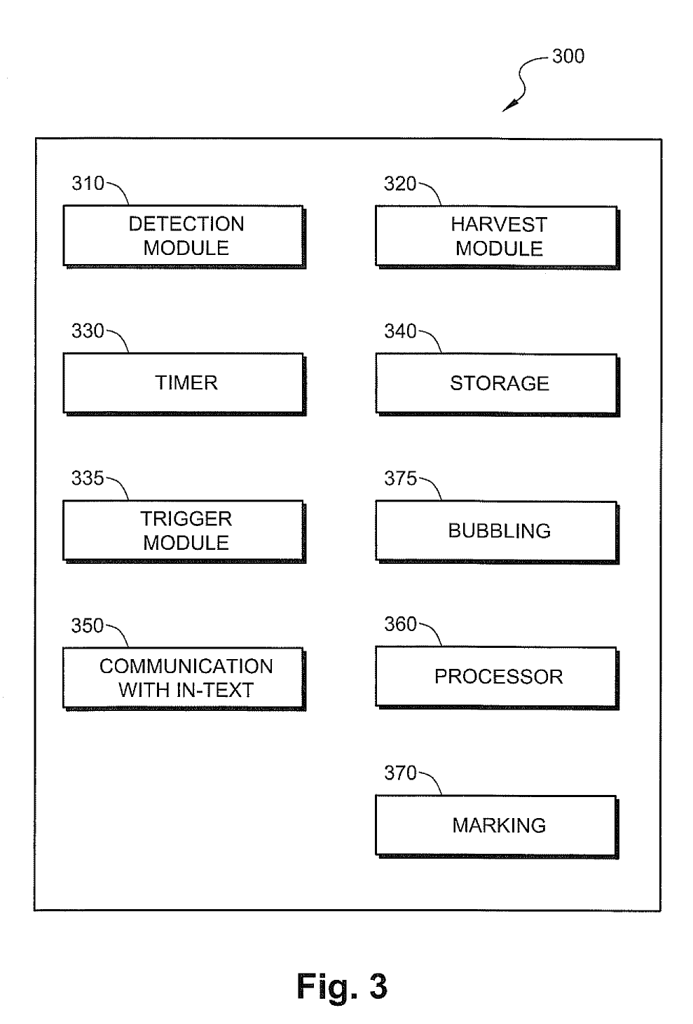

FIG. 3 shows a computerized module for handling a large-scaled document downloaded to a user's computerized device, in accordance with some exemplary embodiments of the subject matter. Computerized module 300 comprises a detection module 310 for detecting changes in the large-scaled document. In some exemplary embodiments of the disclosed subject matter, the computerized module 300 resides in the in-text server (such as 130 of FIG. 1) that receives a request from the user's computerized device (such as 120 of FIG. 1) to analyze the large-scaled document. In some embodiments of the subject matter, the detection module 310 reviews only a portion of the large-scaled document, for example begins reviewing the document from the last segment reviewed on the previous activation.

In some exemplary embodiments of the disclosed subject matter, the large-scaled document, or portions thereof, is received at the browser within the user's computerized device. The detection module 310 periodically detects whether any changes occur in the large-scaled document. For example, detecting whether a new segment of the large-scaled document has been downloaded from the communication server (such as 110 of FIG. 1), new graphic elements has been downloaded, in case the content, graphic or interface of the web page has been modified and the like. Detection module 310 may be a software module that activates a processor to review the large-scaled document, or software or hardware module that performs such review. In some exemplary embodiments of the disclosed subject matter, the computerized module 300 comprises a trigger module 335 that activates the detection module 310 periodically. The activation of the detection module 310 may be time-dependent, for example every about 3 seconds, or event-triggered, for example upon receipt of message that a new segment was downloaded to the user's computerized device. Other events may be mouse or scroller movement. The time-dependent activation may use a timer 330 indicating that a predefined period elapsed since the previous detection, or a result of another event, such as previous download of a segment. In some cases, the time elapsing between consecutive triggering of the detection module 310 may be a function of various parameters, such as the IP address of the user's computerized device, language, data related to the communication server, number of previous segments, amount of data in previous segments and the like.

The large-scaled document is preferably represented by a file written in a markup language such as, XML, HTML or a document written using another application such as Word processor document, PDF files and any other format to represent textual content. Such document comprises text to and/or metadata related to the text to be analyzed. The harvest module 320 receives the segment detected by the detection module 310 and identifies the text of the received data. Harvest module 320 then sends the text to a processor that analyzes the text, either within the user's computerized device, or within an adaptive server, such as in-text server 130 of FIG. 1. The computerized module 300 and its elements may detect, handle, and analyze files using applications that preferably comprise software components written or developed using any programming language such as C, C#, C++, Java, VB, VB.Net, Perl, or the like, and developed under any development environment, such as Visual Studio.Net, Eclipse or the like. Communication between the computerized module 300, the in-text server (such as 130 of FIG. 1) and the user's computerized device may be performed via the internet or via another communication media, such as a telephone network, satellite, physical or wireless channels, and other medias desired to a person skilled in the art.

Computerized module 300 may further comprise storage 340 for storing a set of rules, or settings related to detecting a segment downloaded to the user's computerized device. For example, storage 340 may contain the time elapsing between activation of the detection module 310. Further, storage 340 may contain data related to the in-text server (such as 110 of FIG. 1), preferred communication methods, data related to marking text within the large-scaled document and the like. Computerized module 300 may also comprise a processor 360 for determining which word, group of words or other portion of the large-scaled document are to be marked, and the method of marking the determined one or more words. When a new segment is detected by the detection module 310, at least a portion of the segment, or at least some of the text within the segment are sent to an analyzing module using communication unit 350. Such analysis may provide one or more words to be marked up, the content suggested to the user when pointing or hovering the marked words, method of marking and the like. Communication unit 350 may function using protocols and means as desired by a person skilled in the art, for example using protocols as disclosed above. Computerized module 300 may further comprise operating units to perform the task of marking the predetermined word and providing the commercial content to the user upon pointing, hover, pressing and the like. Such operating units may be a marking unit 370 that marks one or more words as determined by the computerized module 300 or the in-text server (such as 110 of FIG. 1). Marking may be done by highlighting the words, adding a double underline to the words, or any other method desired by a person skilled in the art. Another operating unit is a bubbling unit 375 that creates a bubble or another window upon hover or pointing by the user on a marked word.

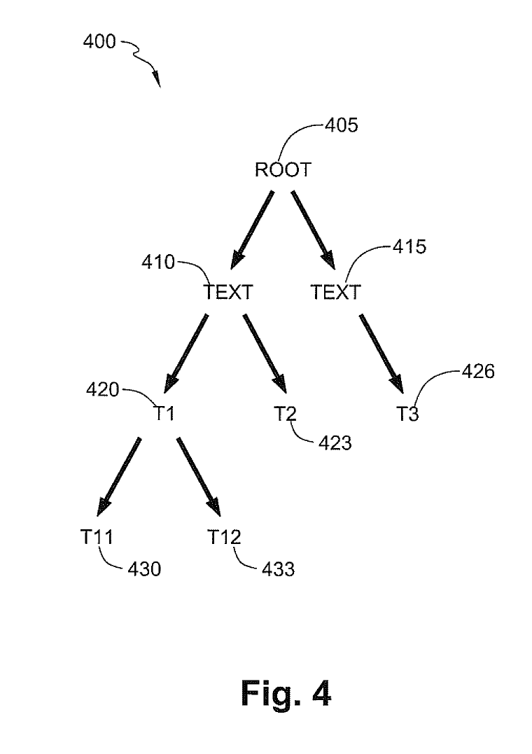

FIG. 4 shows a data structure of a large-scaled document periodically detected by a computerized module, in accordance with some exemplary embodiments of the subject matter. The data structure 400 may represent both text and metadata related to the text of the large-scaled document. The data structure 400 nay be a linked node structure, such as a list, a tree and the like. In such case, each node may represent at least a segment of the large-scaled document, or a portion of a segment. In some embodiments of the disclosed subject matter, the data structure is a hierarchical data structure, in which one node is a parent node or a child node of another node. The data structure 400 contains a root node 405, which nay be the node where the computerized module begins reviewing the large-scaled document. The root node 405 does not have a parent node, and in many cases is the node from which all other nodes can be reached by following edges or links. In some exemplary embodiments of the disclosed subject matter, the root node 405 is connected to other nodes, such as node 410 and 415 using links, edges and the like. In some embodiments, node 410 is connected to nodes that represent text, while node 415 is connected to nodes that represent metadata. In some embodiments, a node in the data structure 400 represents a new segment downloaded to the user's computerized device. Hence, when a new segment is downloaded to the user's computerized device, a new node is added to the data structure 400, for example node 420 or node 423, connected to node 410. In some exemplary embodiments of the disclosed subject matter, when the computerized module reviews the data structure 400 to detect new segment downloaded from the communication server, the detection module reviews nodes in the data structure 400. In some embodiments of the subject matter, once the computerized module reviews the content of a node, the node is assigned a value or a flag such that it need not be reviewed at a later occasion when the data structure 400 is reviewed, to reduce the resources consumed in reviewing and analyzing the large-scaled document. In some other embodiments of the subject matter, a pointer is provided to one or more nodes, to indicate the last node added to the data structure 400 or the last node reviewed. In such case, when the computerized module reviews the large-scaled document, the review begins in or after the last segment detected in the previous detection. The hierarchical structure of the data structure 400 provides for efficient review of the large-scaled file or document, for example by assigning a flag or value to previously reviewed nodes in the data structure, such that only relevant nodes, which represent segments that were not previously reviewed, are reviewed in each iteration.

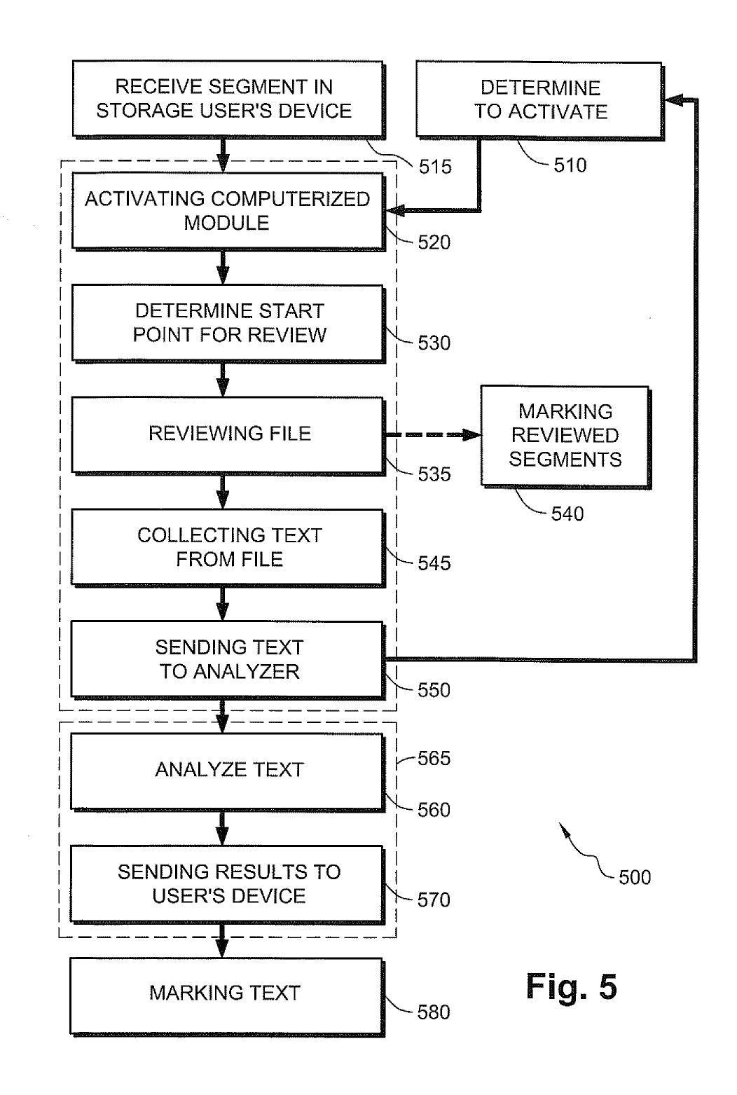

FIG. 5 shows a flow in which a computerized entity handles a large-scaled document downloaded to a user's computerized device, in accordance with some exemplary embodiments of the subject matter. Many steps within the flow 500 are performed in a periodic manner, for example once every about 3 seconds, to maintain continuous detection on whether a segment has been downloaded from a communication server to the user's computerized device, and should be analyzed. In step 510, a processor within the computerized module determines that the large-scaled document is to be reviewed. As disclosed above, such determination may be time-dependent, for example determining to review the document once every about 3 seconds. Alternatively, the determination may depend on the time elapsed since the previous review, the time the user views a web page related to the large-scaled document, the size of the large-scaled document, communication infrastructure and the like. In step 515, which may function as an alternative to step 510, activation of the detection unit is performed upon an event, for example, a command from a receiving unit of the user's computerized device than a specific amount of data has been downloaded to the user's computerized device.

In step 520, once the processor determines that the review is to be performed, the detection module is activated. The detection module then retrieves at least a portion of the large-scaled document. The large-scaled document preferably resides at a storage device related to the browser in the user's computerized device, and the computerized module comprising the detection module either resides in the user's computerized device, in the in-text server (such as 130 of FIG. 1), or in another computerized entity connected to the user's computerized device or to the communication server. The communication server may use applications for transmitting the large-scaled document in segments, such as AJAX technology and other techniques or methods desired by the person skilled in the art. In step 530, the computerized module determines the start point to review the large-scaled document. This step is optional and allows reducing the resources and time required to review the large-scaled document and detect new text that has been downloaded after the previous detection. Determining the start point may be done by previously storing a pointer in the large-scaled document, for example a pointer to a specific memory unit in a data structure (such as 400 of FIG. 4). Such pointer is preferably saved in each review of the large-scaled document and used as a start point in the next review. Alternatively, at least some of the segments represented in the data structure are assigned a value or a flag, such that the computerized module skips to the next segment and does not review the assigned segment.

In step 535, the computerized module reviews the large-scaled document to determine whether a new text segment has been downloaded from the web server. The text segment may be downloaded to the user's computerized device, and in such case, the review may be performed in the user's computerized device. The review may end with a binary message, whether new segment was detected, or with the segment itself. In step 540, the computerized module marks segments in the large-scaled document that has been reviewed, to improve performance of the device performing the review. Marking segments may be performed during reviewing the document. In some exemplary embodiments of the disclosed subject matter, marking segments may contain a step of assigning a flag used to indicate that the computerized module previously reviewed the flagged segment.

In step 545, the computerized module collects the text from the large-scaled document or from the downloaded segment. The large-scaled document comprises text and metadata, such as text size, text location, text font, titles definitions and the like. Collection of the text may be performed by removing the metadata from the document, optionally using the harvesting unit such as 320 of FIG. 3. Additionally, the computerized module may not collect the entire text in case some of the text that may be irrelevant, for example titles, captions and the like. After collecting the text, the computerized module may set the start point for reviewing the large-scaled file the next time. Next, in step 550, the computerized module sends the text to an analyzing module that analyzes the text. The analyzing module may reside in the user's computerized device, or in another device, such as an in-text server (such as 110 of FIG. 1). In some exemplary embodiments of the subject matter, communication between the computerized module, user's computerized device and in-text server is performed via the internet, for example using TCP/IP protocols. In step 560, the analyzing module analyzes the text. The analysis comprises determining which words or group of words should be associated with commercial content. Analysis further comprises marking up the determined words or group of words. Next, analysis may comprise a step of associating the determined words or group of words to specific commercial content according to a predefined set of rules or other data used by the analyzing module. Once the text within the segment of the large-scaled document is analyzed, in step 570 the result, for example one or more words or sentences, or a value representing a word or a sentence, is sent to the user's computerized device to be displayed to the user. In case the analyzing module resides within the user's computerized device, said analyzing module may send the text to the memory related to the display or to the browser. Next, the computerized module returns to step 510, to determine whether it should detect changes in the large-scaled document. In step 580, the some of the text is marked, according to the text analysis. In some embodiments of the disclosed subject matter, steps 520, 530, 540, 545 and 550 are likely to be performed in the user's computerized device, while steps 560 and 570, grouped as 565, are likely to be performed at the in-text server.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

1. A method of analyzing a large-scaled file downloaded to a user's computerized device in segments, comprising:
determining to detect changes in the large-scaled file;
activating a computerized module to review the large-scaled file;
reviewing at least a portion of the large-scaled file to determine whether an at least one new segment has been added to the large-scaled file since a previous review of the large-scaled file.

2. The method according to claim 1, further comprises a step of collecting the text from the at least one new segment.

3. The method according to claim 1, further comprises a step of determining the start point for reviewing the at least a portion of the large-scaled file.

4. The method according to claim 1, further comprises a step of sending the text of the at least one new segment to an analyzing module, to be associated with commercial content.

5. The method according to claim 1, further comprises a step of determining at least one word from the large-scaled file to be associated with commercial content.

6. The method according to claim 1, further comprising a step of associating commercial content to at least one word from the at least one new segment.

7. The method according to claim 1, further comprising a step of assigning a value or flag to previously reviewed segments of the large-scaled file.

8. The method according to claim 1, wherein reviewing the at least a portion of the large-scaled document begins at a pointer assigned at a previous review of the large-scaled file.

9. The method according to claim 1, wherein the large-scaled file is downloaded using an asynchronous technology.

10. The method according to claim 9, wherein the asynchronous technology is AJAX.

11. A computer program product, comprising a computer usable medium having a computer readable program code embodied therein, said computer readable program code adapted to be executed to implement a method of analyzing a large-scaled file downloaded to a user's computerized device in segments, comprising:
determining to detect changes in the large-scaled file;
activating a computerized module to review the large-scaled file;
reviewing at least a portion of the large-scaled file to determine whether an at least one new segment has been added to the large-scaled file since a previous review of the large-scaled file.

12. A system for analyzing a large-scaled file downloaded to a user's computerized device in segments, comprising
a detection module for reviewing at least a portion of the large-scaled file and detect an at least one new segment added to the large-scaled file since a previous review of the large-scaled file;
a triggering module for triggering the detection module;
an analyzing module for analyzing at least the text of the at least one new segment detected by the detection module.

13. The system according to claim 11, wherein the trigger is provided in a periodic manner.

14. The system according to claim 11, further comprises a collection module for collecting the text from the at least one new segment and send the text to the analyzing module.

15. The system according to claim 11, wherein the triggering module is a timer indicating the time elapsed since a previous review of the at least a portion of the large-scaled document.
